(19) United States
(12) Patent Application Publication
(10) Pub. No.: US 2012/0256121 A1
(43) Pub. Date: Oct. 11, 2012

(54) METHOD FOR PRODUCING GRAPHENE SOLUTIONS, GRAPHENE ALKALI METAL SALTS, AND GRAPHENE COMPOSITE MATERIALS

(75) Inventors: Aurel Wolf, Wulfrath (DE); Giulio Lolli, Koln (DE); Leslaw Mleczko, Dormagen (DE); Oliver Felix-Karl Schluter, Leverkusen (DE)

(73) Assignee: BAYER TECHNOLOGY SERVICES GMBH, Leverkusen (DE)

(21) Appl. No.: 13/508,189

(22) PCT Filed: Nov. 8, 2010
(86) PCT No.: PCT/EP2010/067008

§ 371 Date: Jun. 25, 2012

(30) Foreign Application Priority Data
Nov. 12, 2009 (DE) 102009052933.0

(51) Int. Cl. H01B 1/04; C09K 5/00; C01B 31/30; B82Y 40/00; B82Y 30/00

(52) U.S. Cl. 252/74; 252/506; 423/439; 977/734; 977/896

(57) ABSTRACT

The present invention relates to a process for preparing graphene solutions by means of alkali metal salts, to graphene solutions, to processes for preparing graphene alkali metal salts, to graphene alkali metal salts and to graphene composite materials and to processes for producing the graphene composite materials.

The present invention relates to a process for preparing graphene solutions by means of alkali metal salts, to graphene solutions, to processes for preparing graphene alkali metal salts, to graphene alkali metal salts and to graphene composite materials and to processes for producing the graphene composite materials.

Graphene comprises two-dimensional carbon crystals with an analogous structure to individual graphite layers. The carbon atoms are arranged in a hexagonal honeycomb structure. This arrangement results from the hybridization (“fusion”) of the 2s, 2px and 2py orbitals of the carbon atoms involved to give what are known as sp² hybrid orbitals. Graphene has metallic and nonmetallic properties. The metallic properties of graphene relate to the good electrical and thermal conductivity. The nonmetallic properties result in a high thermal stability, chemical inertness and lubricity of these compounds. Graphene is therefore suitable for a multitude of industrial applications, for example for batteries, fuel cells or refractory materials.

The first graphene flakes were obtained by Novoselov [K. S. Novoselov, et al.; Science 306, 5696, 2004, p. 666-669] by exfoliation of HOPG (highly oriented pyrolytic graphite). This was done by pressing adhesive tape onto the HOPG and then pulling it off; this leaves graphite in the adhesive. Subsequently, the adhesive strip is pressed onto a silicon wafer with a thin silicon dioxide layer and pulled off again. Thereafter, graphene becomes visible by suitable optical methods. This method is very time-consuming, and only very few, albeit high-value, samples are obtained.

In addition to mechanical exfoliation, there is synthesis from organic molecules (see, for example, L. Zhi, et al.; J. Mater. Chem. 18, 18, 2008, p. 1472-1484) and chemical exfoliation, for example by intercalation of oxidizing acids, for example nitric acid, or oxidizing salts, for example potassium permanganate or potassium chromate, in graphite and subsequent thermal or mechanical treatment to produce graphene with a thickness around 20 nanometres, which corresponds to about 40-50 graphene layers [U.S. Pat. No. 4,895,713]. The production of fewer graphene layers is not possible by this process.

A further process relates to the preparation of graphene oxide by means of strong oxidizing agents. The graphene oxide generated by this process is similar in morphological terms to a graphene layer, but is different in chemical terms from graphene as a result of the fully oxidized state. By means of toxic and environmentally harmful liquid hydrazine, it is possible to reduce the graphene oxide generated by this process further in order ultimately to obtain graphene [Stakovich, S. et al. Jour. of Mat. Chem. 2006, 16; 155-158].

The disadvantages of the known processes described are the low yield of graphene, generation to give thicker graphene layers and the necessity of using toxic, environmentally hazardous and expensive chemical agents to prepare graphene. There is accordingly still a need for novel processes for preparing graphene, which can address and overcome the disadvantages of the prior art.

It was accordingly an object of the present invention to provide such a novel process for preparing graphene. According to the invention, the object is achieved by the provision of a process for preparing a graphene solution, in which graphite is reduced with an alkali metal salt in a polar organic solvent.

One advantage of the process is the avoidance of use of toxic, environmentally harmful and expensive agents for the preparation of the graphene solution. Thermal treatment with temperatures of 700° C. to 1200° C., as described for particular chemical exfoliation methods, is not necessary either. A further advantage of the present process according to the invention lies in the scalability and the associated possibility of preparing graphene on the industrial scale. Moreover, the process according to the invention also enables the preparation of graphene with a layer thickness of less than 20 nanometres, i.e. down to graphene with only one graphene layer (0.34 nm). The layer thickness can be controlled precisely by the process according to the invention via the amount of reducing agent added (see FIG. 2). It is thus possible, for example, to produce different products with the same industrial scale plant and minimal changes to the reaction conditions (such as the amount of the reducing agent added). A further advantage arises from the graphene solutions preparable by the process according to the invention, in that they can be processed easily in connection with a surface functionalization of substrates, especially with conventional printing, coating and impregnation methods.

Preferably in accordance with the invention, an alkali metal salt of the following formula is added to the process for preparing a graphene solution:
A⁺B⁻
characterized in that
A⁺ is a cation of an alkali metal ion, especially with lithium or sodium, and
B⁻ is an anion of a polyaromatic compound.

The anion used is preferably a polyaromatic compound. The examples thereof include naphthalene, anthracene, carbazole, perylene, phenanthrene, coronene, chrysene, triphenylene, fluorenone, benzophenone and/or anthraquinone. Particular preference is given to the use of naphthalene.

Suitable polar organic solvents for the process for preparing a graphene solution are especially tetrahydrofuran (THF), acetonitrile, 1,2-dimethoxyethane (DME), diethylene glycol diethyl ether, tri- or tetraethylene glycol dimethyl ether, sulpholane (tetramethylene sulphone), tetramethylene sulphoxide (TMSO), N,N-diethylacetamide, N,N-dimethylacetamide (DMAc), N,N-dimethylformamide (DMF), N-methylpyrrolidone (NMP), dimethyl sulphoxide (DMSO), dimethyl sulphone, diphenyl sulphoxide, diphenyl sulphone, tetramethylurea, tetra-n-butylurea, 1,3-dimethylimidazolidin-2-one (DMI), other glycol ethers or mixtures thereof. Preferred organic solvents are glycol ethers such as 1,2-dimethoxyethane (DME), diethylene glycol diethyl ether, tri- or tetraethylene glycol dimethyl ether or mixtures thereof.

For the process according to the invention, the polyaromatic compound is preferably first dissolved in the (very substantially anhydrous) polar organic solvent, preferably in a ratio of 10 mM (1:100) to 1M (1:1) and preferably while stirring. Thereafter, the alkali metal is supplied to this solution, preferably in a slight stoichiometric excess, i.e. in a ratio to the solution of 11 mM to 1.1M. The alkali metal is preferably supplied in very small pieces (for example by cutting up a wire, etc.), in order to facilitate the dissolution of the alkali metal. The solution thus obtained is preferably heated to a temperature of 60° C. to 120° C. over a period of preferably 15 minutes to 2 hours, in order to accelerate the dissolution of the alkali metal. If the solution thus obtained, which is also referred to hereinafter as “reducing agent”, is not used further directly, it can be cooled and stored thus for later uses over a prolonged period.

In the process according to the invention for preparing the graphene solution, graphite is then added to the reducing agent, preferably while stirring. It is particularly suitable to use very finely ground graphite, which can be obtained especially by the mechanical processing techniques which are common knowledge to the person skilled in the art. The exfoliation and dissolution step is supported by very finely ground graphite. This step is performed until a stable graphene solution is obtained, in which a minimum level of deposits remain visible.

The process according to the invention is preferably performed with a ratio of graphites to the alkali metal of less than 4000 g of graphite per mole of alkali metal and preferably of less than 20 g of graphite per mole of alkali metal.

The process according to the invention for preparing the graphene solution is as far as possible performed under inert conditions. The term “inert conditions” according to the present invention refers to conditions under which a minimum amount or very substantially no water or oxygen comes into contact with the agents used to prepare the graphene solution for the process according to the invention, or solutions and compounds resulting therefrom. This can be ensured by performing the process according to the invention preferably in an inertization space, for example a glovebox, which can be sealed essentially gas-tight and is filled with an inert gas atmosphere (for instance nitrogen or argon). The person skilled in the art is aware of corresponding alternative apparatus and systems.

The present invention further relates to a solution—referred to in this application as “graphene solution”—in which (negatively charged) graphene, a polyaromatic compound and a (positively charged) alkali metal are present dissolved in a polar organic solvent. The polyaromatic compounds, alkali metals and polar organic solvents suitable for such a graphene solution have already been described above. The present invention further relates to a graphene solution which is prepared by the above-described process for preparing the graphene solution. Graphene solutions are preferably stored under inert conditions.

The present invention also relates to a process for preparing a graphene alkali metal salt by evaporating the solvent of the inventive graphene solution. Equipment or processes suitable for the evaporation, for example a rotary evaporator, are known to the person skilled in the art. This process preferably also evaporates the polyaromatic compound, for example in the case of use of naphthalene. In the case of use of other polyaromatic compounds which cannot be removed by evaporation, it is possible to use other extraction methods known to those skilled in the art in order to remove any polyaromatic compounds. The present invention further also provides a graphene alkali metal salt which can be prepared by such a process.

The invention further relates to a process for preparing a graphene solution—referred to hereinafter as “purified graphene solution”—in which the graphene alkali metal salt, which can be prepared by the above-described process for preparing a graphene alkali metal salt by evaporating the solvent, is dissolved in an aprotic organic solvent, preferably under inert conditions and preferably in a ratio to the graphene alkali metal salt of 1:100 to 1:1. Suitable aprotic organic solvents are especially aprotic polar organic solvents and therefore preferably in turn those which have already been described above by way of example for the polar organic solvents. The advantage of this process step is especially that, with regard to further processing steps, the opportunity is available to dissolve the graphene in another solvent more suitable for the further processing. If, for example, the purified graphene solution is used for the production of an inventive composite material, the graphene alkali metal salt can also be dissolved in this step in a solvent suitable for the substance to be added. For example, for the production of a graphene-polystyrene composite material, the alkali metal salt is preferably dissolved in DMF because polystyrene also dissolves efficiently in DMF. The person skilled in the art is aware of which aprotic organic solvents have to be used for the specific fields of use of the purified graphene solution. The invention also relates to a purified graphene solution prepared by this process. Such a purified graphene solution is preferably stored further under inert conditions until it is used.

If desired, the neutral character of the graphene can be reestablished by exposing the graphene solution or the purified graphene solution to air or water. This can be useful in connection with the use of the graphene solution or of the purified graphene solution with other polymers and especially in the production of polymer fibres. The graphene salt can be converted to pure graphene within the polymer or the spun polymer fibres, on contact with air or water, for example in the course of the maturing or drying step of the spun polymer fibres.

The inventive graphene solution or the inventive purified graphene solution can also be used, for example, to functionalize surfaces of materials and especially of polymers. For this purpose, the surfaces of these materials are impregnated, coated or printed with the inventive solutions. For example, electrical materials such as silicon wafer can be coated or imprinted with the graphene solution or purified graphene solution in order to produce novel microelectronic components, for example transistors (with electrical circuits formed from graphene). The graphene solution or the purified graphene solution enables particularly simple processability, which makes them materials of interest especially for use with conventional printing techniques and microlithography.

Compared to a graphene oxide-impregnated, coated or printed substrate, in which agents such as hydrazine as described above are required to obtain pure graphene (which can affect the substrate), only exposure with ambient air is required in the case of a substrate impregnated, coated or printed with the graphene solution or the purified graphene solution.

A further process according to the invention describes the production of a composite material using the inventive graphene solution or the inventive purified graphene solution, and the addition of a further substance, preferably while stirring, and subsequent further processing to give the composite material with a suitable finishing process.

Suitable substances which can be added to the graphene solution or the purified graphene solution are, for example, plastics, metals or ceramic materials. These are added to the graphene solution or purified graphene solution in such a ratio as to give rise to a composite material with a proportion by weight of graphene of preferably less than 10% and more preferably of less than 5% and most preferably of less than or equal to 2%, preferably between 0.1 and 1%. Examples of suitable polymers for the inventive composite material are nylon, polyvinyl chloride, poly(methyl) methacrylate, polystyrene, polyethylene, polypropylene, polycarbonate, epoxy resins, polyfluorinated hydrocarbons, polyimides, polyamides, fluorinated polymers, acrylamides, polyesters, cyanate esters and mixtures thereof. Suitable metals are especially aluminium, magnesium, titanium, and alloys thereof. Alloys with copper, such as brass or bronze, are also suitable for the production of the inventive composite material. Suitable ceramic materials are, for example, oxide ceramics such as aluminium oxide or beryllium oxide, nonoxide ceramics such as silicon carbide, boron nitride, boron carbide or composite ceramics.

Suitable substances are preferably added in powder form or as fine granules to the graphene solution or purified graphene solution.

Suitable finishing processes are especially heat treatment processes, for example sintering. The graphene solution or purified graphene solution admixed with the additional substance is exposed to an oxygen environment and heat treated at a suitable temperature and a suitable pressure. The suitable conditions (temperature, pressure, residence time, etc.) depend on the substance added (and not on graphene). For example, the temperature in the case of use of a metal or of an alloy should be close to but below the melting temperature of the metal or of the alloy. The person skilled in the art is aware of which factors have to be taken into account depending on the substances used.

The present invention further also provides composite materials which can be obtained by the above-described process for producing the composite materials.

The inventive composite materials can be used, for example, for thermally and/or electrically conductive products. Illustrative uses of the inventive composite materials are those in batteries, capacitors, paints, other coatings or catalysts. The person skilled in the art is aware of the further applications for which the composite materials described can be used.

### FIGURES

FIG. 1: Illustrative diagram of an inventive purified graphene solution, in which graphene (negatively charged) and an alkali metal (e.g. lithium ions) are present dissolved in an aprotic organic solvent (e.g. THF).

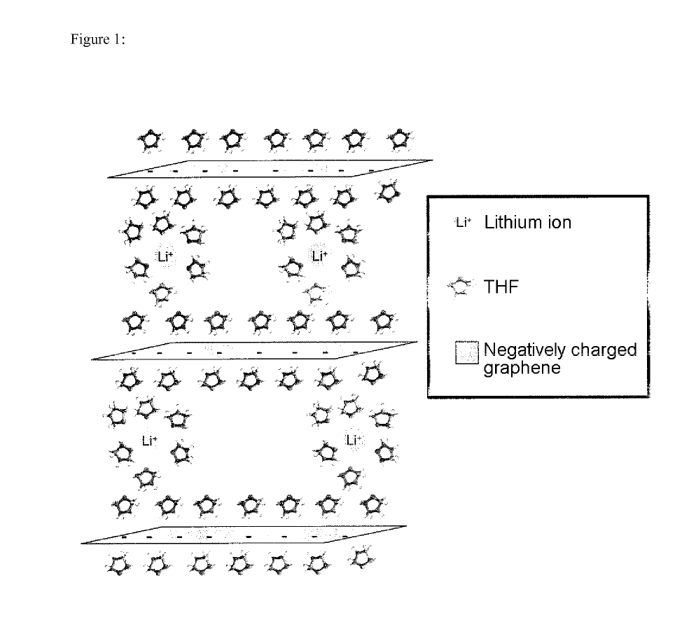

FIG. 2: Number of graphene layers as a function of the graphite:alkali metal ratio. It becomes clear from the figure that, at a ratio of less than 20 g of graphite per mole of alkali metal, a graphene layer can be obtained in the inventive graphene solution.

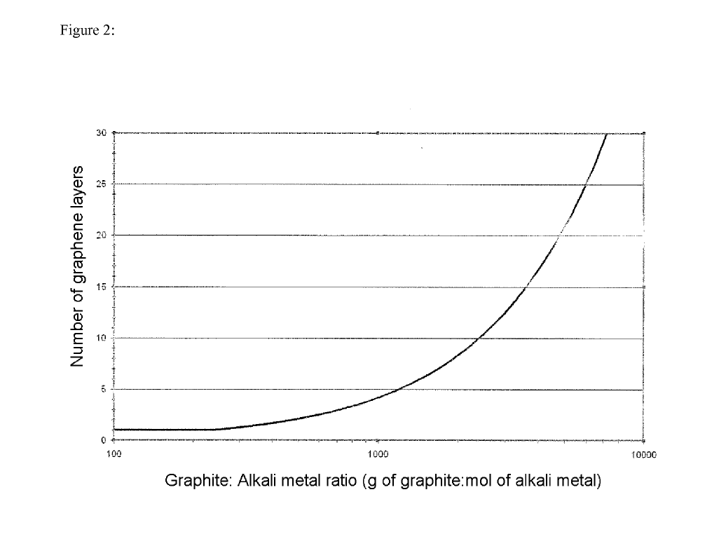

### EXAMPLES

### Example 1

Owing to water and oxygen sensitivity, it is important that the experiment is as far as possible performed in an inert atmosphere. Suitable for this purpose is, for example, a glovebox filled with an inert gas, for example nitrogen or argon.

Step 1: Preparation of the Reducing Agent

The reducing agent is prepared by dissolving 384 mg of naphthalene (3 mmol) in 100 ml of anhydrous THF in a round-bottomed flask while stirring, and then adding metallic lithium to the solution in a slight stoichiometric excess (approx. 30 mg). In order to facilitate the dissolution of the alkali metal, the alkali metal should be supplied in very small pieces. The mixture is then heated up to boiling point of THF (66° C.) under reflux for about 2 to 3 hours. During this time, the alkali metal dissolves in the naphthalene/THF solution (visible by reduction in size of the alkali metal particles) and the mixture turns dark green (typical of Li-naphthalene complexes). The reducing agent is cooled and used further.

Step 2: Dissolution of the Graphite Material

200 mg of graphite are added to the reducing agent prepared in step 1. In order to promote the exfoliation and dissolution step, very finely ground graphite should be used. The graphite/reducing agent suspension is then stirred for about 30 minutes. During this step, the dark green solution turns brown-black and the Li-naphthalene complexes are converted. After this step, the suspension is stable. No deposits are visible.

Step 3: Preparation of a Graphene-Lithium Salt

A graphene-lithium salt solid can be purified by evaporating the THF solvent by means of a rotary evaporator or other known methods usable therefor. The resulting solid is dissolved under an inert atmosphere in a polar aprotic organic solvent, for example THF, DMF, DMSO, DME or other glycol ethers, and used for the intended purpose.

### Example 2

10 g of aluminium powder (300 mesh) are added to the THF/Li-graphene solution prepared in Step 2 of Example 1, and homogenized by stirring. Thereafter, this solution can be exposed to oxygen and sintered in order to obtain a 2% graphene/Al composite material. The graphene is present in fine distribution in the composite material.

1. A process for preparing a graphene solution comprising reducing graphite with an alkali metal salt in a polar organic solvent.

2. The process according to claim 1, wherein said alkali metal salt comprises:
A+B−
wherein
A+ is a cation of an alkali metal ion, optionally especially with lithium or sodium, and
B− is an anion of a polyaromatic compound.

3. A graphene solution in which graphene, a polyaromatic compound and said alkali metal dissolved in a polar organic solvent are present.

4. The graphene solution prepared by a process according to claim 1.

5. The process for preparing a graphene alkali metal salt comprising evaporating the polar organic solvent of the graphene solution according to claim 3.

6. The graphene alkali metal salt prepared by the process according to claim 5.

7. A process for preparing a purified graphene solution, comprising dissolving said graphene alkali metal salt according to claim 6 in an aprotic organic solvent.

8. The purified graphene solution prepared by the process according to claim 7.

9. A process for producing a composite material, comprising adding a substance to said graphene solution according to claim 3, and processing said graphene solution by a manufacturing process to give a composite material.

10. A composite material produced by the process according to claim 9.

11. A process for producing a composite material, comprising adding a substance to said graphene solution according to claim 4, and processing said graphene solution by a manufacturing process to give a composite material.

12. A process for producing a composite material, comprising adding a substance to said purified graphene solution produced according to claim 8, and further processing said purified graphene solution by a manufacturing process to give a composite material.

13. A composite material produced by the process according to claim 11.

14. A composite material produced by the process according to claim 12.
